(19) United States
(12) Patent Application Publication
(10) Pub. No.: US 2008/0181979 A1
(43) Pub. Date: Jul. 31, 2008

(54) HOT PRESS FOR COATING WORK PIECES, IN PARTICULAR FURNITURE PARTS, AS WELL AS WORK TABLE THEREFOR

(75) Inventor: Reinhard Huber, Freudenstadt-Dietersweiler (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: Robert Burkle GmbH, Freudenstadt (DE)

(21) Appl. No.: 11/946,235

(22) Filed: Nov. 28, 2007

(30) Foreign Application Priority Data
Jan. 20, 2007 (DE) 102007002997.9

(51) Int. Cl. B29B 11/06; A47B 41/06

(52) U.S. Cl. 425/340; 108/28

(57) ABSTRACT

A hot press for coating work pieces on their upper surfaces and lateral surfaces with a film as well as a work table therefor. The hot press includes a press table with a heating plate in the lower frame, displaceable in reference to the press table, having an upper frame, connections for pressurizing and/or evacuating the volumes circumscribed by the upper and lower frames, as well as at least one work piece carrier for supporting a work piece to be coated. A mold frame is provided in the lower frame at least partially encompassing the work piece carrier, which forms the edge of an area that is curved at least partially convexly or essentially cylindrically.

### BACKGROUND

The invention relates to a hot press for coating work pieces, in particular furniture parts, with a film at their upper side and lateral surfaces. The invention further relates to a work table for such a hot press.

A hot press of this type comprises a press table with a lower frame, a heating plate displaceable in reference to the press table having an upper frame, means for pressurizing and/or evacuating the volumes circumscribed by the upper and the lower frame, as well as at least one work piece carrier to support the work piece to be coated.

In particular in the production of furniture parts frequently wood composite board made from wood fibers or chips are used, with their upper surfaces and lateral surfaces being coated with a film. In the context of the present invention the term film comprises both plastic films and the like as well as veneers glued in the form of a film onto a wooden composite board to produce valuable furniture boards.

Hot presses of the type mentioned at the outset are primarily used to coat three-dimensionally profiled furniture parts. They are placed onto the press table onto the work piece carrier, with the work piece carrier having a smaller surface than the work piece to be coated so that the bottom of the work piece is not supported at its edges. Subsequently the film provided for coating the work piece is inserted between the upper and the lower frame, covering the lower frame over its entire surface. Due to the fact that, when the hot press is closed, the coating occurs within a closed frame with its interior space being pressurized, and/or evacuated, the film is made to contact the work piece three-dimensionally with the help of a pressure difference of the space above the film in reference to the space below the film, in particular around its lateral surfaces up to their bottom edges. The heating plate arranged above heats the film, essentially by heat radiation, so that an adhesive applied in advance to the film or to the work piece is activated and the film adheres to the surface as well as the lateral surfaces of the work piece, following its profile.

In the hot press of the present invention, generally more than one work piece carrier is provided, in order to allow the simultaneous coating of several work pieces. The heating plate is displaceable in reference to the press table within the scope of the invention, which means that either the heating plate can be displaced vertically or the press table can be displaced upwards against the heating plate. If necessary, both the press table as well as the heating plate can be displaced vertically. The pressure difference between the space above the film and below the film in the closed frame of the hot press can occur by pressurizing the upper space or, preferably, by evacuating the lower space, or by both of them simultaneously.

Examples for a hot press of the present type as well as a respective work table are found in prior art, for example in EP 1 172 171 A1 or DE 43 07 816 A1.

As already mentioned, the film heated by the heating plate and thus made flexible contacts the upper surface of the work piece as well as its lateral surfaces such that it contacts the work piece slightly beyond the lateral surfaces towards the back, around the bottom edge, at the edge of the back of the work piece. Naturally, in this area the film is particularly widely stretched. When furniture pieces are coated that are embodied in a curved shape the lateral surfaces themselves form an undercut for the film so that the film can only contact the back side of the work piece through stretching around the bottom edge to a particular extent. When the work piece is not curved convexly but, as for example in cylindrically bulging doors of bathroom cabinets, in a manner of a cylindrical casing surface, additional particularly wide stretching of the film develops at the faces of the lateral surfaces because here the differences in height between the center and the edge areas of the front surface must be compensated by the film stretching. This sometimes leads to unsatisfactory results in the coating.

### SUMMARY

The present invention is therefore based on the object to optimize a hot press and a work table of the type mentioned at the outset for curved work pieces.

This object is attained in a hot press as well as a work table having the features of the invention.

Preferred embodiments and further developments of the invention are discernible from the description and claims.

In the present invention the hot press known per se and the respective work table is modified such that in the lower frame and/or inside the frame of the work table a mold frame is provided, at least partially and/or sectionally surrounding the work piece carrier, forming the edge of an at least partially convexly or essentially cylindrically curved surface. Due to the fact that the film is supported on this mold frame and preferably is stretched thereupon it does not extent parallel in reference to the press table and thus accordingly contacts the curved work piece along a curved surface so that, similar to (the method) in prior art for flat work pieces, it must also be deflected only by approximately 90° in order to allow it to contact the lateral surfaces of the work piece. In this way, the excessive stretching that developed in prior art is therefore avoided in curved work pieces.

The embodiment of the mold frame according to the invention is therefore adjusted to a work piece that is curved convexly or essentially cylindrically, or which may be curved only partially convexly, i.e. wavy or staggered or the like.

It is particularly advantageous for the work piece carrier to be embodied curved in an appropriate manner to support the curved work piece adjusted to its shape.

Particular advantages are offered when the mold frame is provided with a base plate, which is preferably embodied in an exchangeable manner, so that if necessary a curved mold can be selected precisely matching the respective work piece. The curved base plate, together with the curved mold frame according to the invention and the curved work piece, then forms a space to be evacuated underneath the film, which essentially comprises the form of a spherical shell, an ellipsoid, or the like or a cylindrical element and accordingly it is equivalent to the projection of hot presses known from prior art to a curved surface. The requirements for stretchability of the film for application are therefore equivalent to the requirements of a film for hot presses according to prior art for coating flat work pieces.

Here, the exchangeability of the base plate allows a quick adjustment of the hot press according to the invention as well as the respective work table to differently curved work pieces. It is not mandatory for the bending of the mold frame to be adjustable; however, it may also be embodied in an adjustable manner. The mold frame itself is preferably embodied in an encompassing fashion, which is not mandatory, though. In particular for cylindrically curved work pieces a mold frame can be selected surrounding the work piece at the front sides of the work piece only.

The lower frame of the hot press according to the invention can be embodied as a pallet or can be arranged in a pallet, with the pallet being provided with the work piece and if necessary also the work piece carrier and the mold frame outside the hot press, and can be inserted into the hot press for coating. This technology is also known in prior art from the documents mentioned at the outset.

### BRIEF DESCRIPTION OF THE DRAWINGS

In the following an exemplary embodiment of the present invention is described and explained in greater detail using the attached drawing. Shown are:

FIG. 1 a work table embodied according to the invention in a lateral cross-sectional view;

FIG. 2 the work table of FIG. 1 with a film for coating; and

FIG. 3 a core area of the work table of FIG. 1 in a perspective view.

### DETAILED DESCRIPTION OF THE PREFERRED EMBODIMENTS

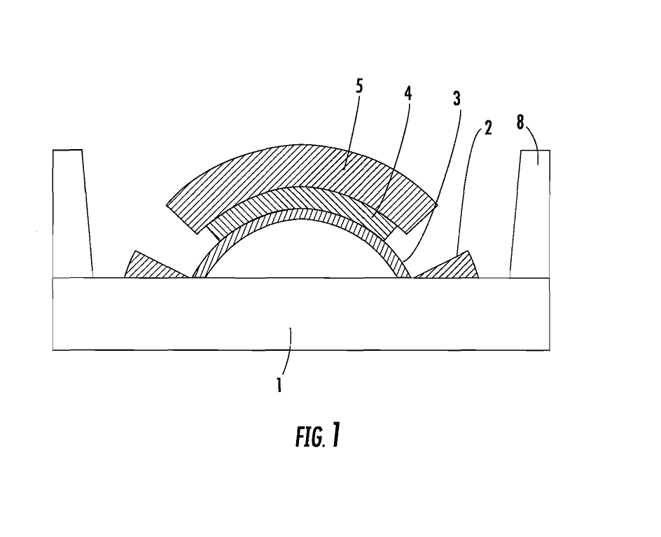

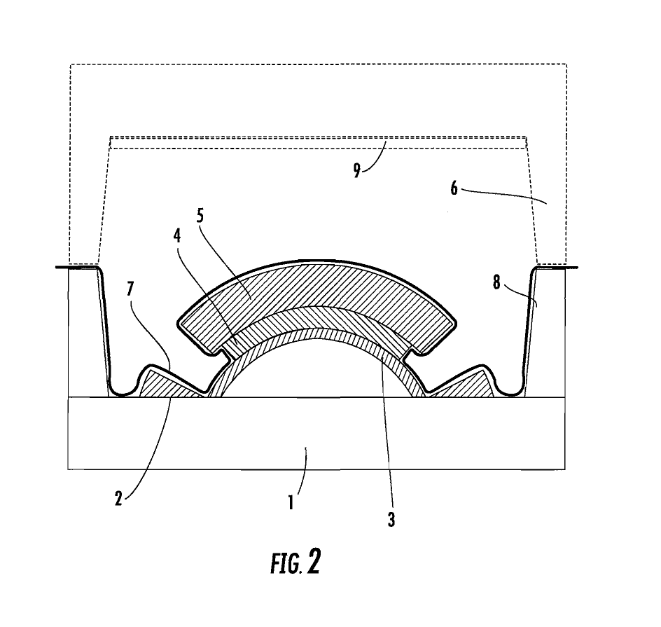

In FIG. 1, in a lateral cross-section a work table 1 of a hot press, otherwise not shown, is illustrated schematically. Only in FIG. 2 additional functionally important parts of the hot press are indicated in dashed lines.

The work table 1 shown in FIG. 1 is embodied as a mobile pallet and is shown with a lower frame 8 of the hot press. On the work table 1, inside the lower frame 8, an additional mold frame 2 is arranged, forming the edge area of a curved surface according to the invention, in the present example, a cylindrical surface. Inside the mold frame 2 an exchangeable base plate 3 is located, having a work piece carrier 4 thereupon, both of are being curved in the form of a cylindrical casing. A curved work piece 5 is supported on the work piece carrier 4, which is to be coated with a film.

FIG. 2 shows how a film 7 contacts the work piece 5 during coating. The dashed lines only indicate how the pallet cooperates with the work table 1 inserted in the (otherwise not shown) hot press, provided with a lower frame 8, having an upper frame 6 and a hot plate 9 arranged thereat. By lowering the upper frame 6 with the heating plate 9 and/or by raising the work table 1 with the lower frame 8, the hot press is closed and the interior space between the lower frame 8 and the upper frame 6 is sealed airtight. The film 7 located therebetween also separates the interior space between the upper frame 6 and the lower frame 8 airtight into a space located above the film 7 and a space located below the film 7. In particular, by heat radiation from the heating plate 9, supported if necessary by suctioning known per se from prior art of the film 7 towards the heating plate 9, the film 7 becomes flexible via heating. By introducing a slight pressure to the upper space or a slight evacuation of the lower space via connections to a pressure supply or vacuum, the film 7 first contacts, in the form of a cylindrical casing surface with a continuous curve, the mold frame 2 and the work piece 5 and can be stretched to the mold frame 2.

By a subsequent evacuation of the space formed between film 7 and the lower frame 8 via a vacuum connection, the film is particularly pulled downwards between the mold frame 2 and the work piece 5 and is placed onto the surface of the work piece 5. Due to the fact that the edge areas of the work piece 5 extend beyond the work piece carrier 4, the film 7 is pulled down beyond the bottom edge of the lateral surfaces of the work piece 5 to the base plate 3. As is discernible from this view, no deflections of the film 7 develop that would not also develop in flat work pieces according to prior art. This is particularly caused by the curved embodiment of the lower mold frame 2 and supported effectively by the preferred curving of the base plate 3. As clearly discernible from this illustration, less curved work pieces 5 can also be beneficially coated with a film 7 using an unchanged mold frame 2; however, using an exchangeable base plate 3, so that it is sufficient to embody the base plate 3 such that it can be exchanged in order to use the hot press according to the invention and/or the work table 1 according to the invention for differently curved work pieces 5.

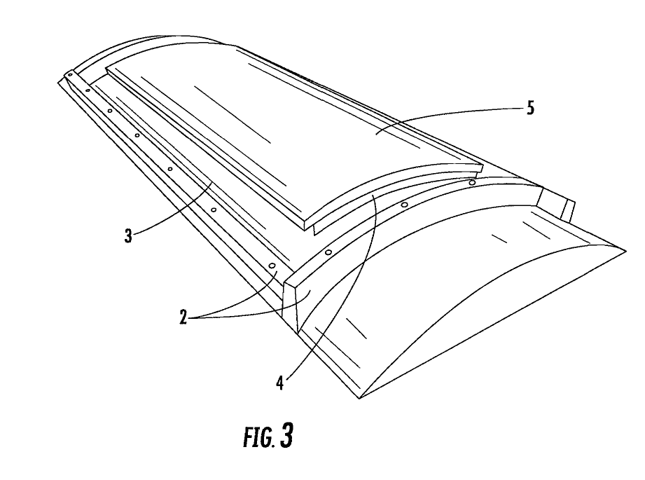

FIG. 3 shows the core region of the work table 1 of FIG. 1 in a perspective view in order to more clearly show the form of the mold frame 2 adjusted to the work piece 5. The work piece 5 is here curved cylindrically so that the mold frame 2 is also embodied such that it forms the edge of a cylindrically curved surface. This is most striking at the front sides of the work piece 5, where the shape of the mold frame 2 prevents the film (not shown here) placed onto the work piece 5 from being excessively stretched at the face.

The base plate 3 shown in FIG. 3 is also adjusted to the work piece 5 and thus curved cylindrically. In the example shown here, the mold frame 2 is mounted to the base plate 3 so that combined therewith it forms an interchangeable unit for supporting the work piece carrier 4. As described above, the mold frame 2 can also be mounted to the work table 1 separated from the base plate 3, so that the base plate 3 and the work piece carrier 4 located thereupon can be exchanged independent from the mold frame 2.

Finally, it shall be mentioned that of course the hot press according to the invention may also comprise several base plates, mold frames 2, and work piece carriers 4, as shown in FIG. 3, arranged on the very same work table 1 side-by-side, in order to allow the simultaneous coating of several work pieces 5 in a single operational step.

1. A hot press, for coating work pieces with a film on upper sides and lateral surfaces thereof, comprising a press table with a lower frame (8), a heating plate (9) with an upper frame (6) that can be displaced in reference to the press table, connections for pressurizing and/or evacuating volumes defined by the upper and lower frames, and at least one work piece carrier (4) for supporting a work piece (5) to be coated, a mold frame (2) is provided within the lower frame (8), at least partially encompassing the at least one work piece carrier (4), and forms an edge of a surface that is curved at least partially convexly or essentially cylindrically.

2. A hot press according to claim 1, wherein the lower mold frame (2) serves to stretch the film (7) provided to coat the work piece (5).

3. A hot press according to claim 1, wherein the at least one work piece carrier (4) for supporting the work piece (5) to be coated is curved at least partially convexly or essentially cylindrically.

4. A hot press according to claim 1, wherein within the lower frame (2), a base plate (3) that is adjusted to the work piece carrier (4) is provided.

5. A hot press according to claim 4, wherein the base plate (3) is interchangeable.

6. A hot press according to claim 1, wherein the lower frame (8) comprises a mobile pallet or is arranged on a pallet.

7. A work table, for a hot press to coat work pieces with a film at upper side and lateral surfaces thereof, comprising a frame (8) to support and stretch the film (7), a work piece carrier (4), as well as a connection to evacuate the space formed inside the frame (8) below the film (7), a mold frame (2) is provided inside the frame (8), at least partially encompassing the work piece carrier (4), which forms an edge of a surface that is at least partially curved convexly or essentially cylindrically.

8. A work table according to claim 7, wherein the mold frame (2) stretches the film (7) provided to coat the work piece (5).

9. A work table according to claim 7, wherein the work piece carrier (4) is at least partially convex or essentially curved cylindrically.

10. A work table according to claim 7, wherein a base plate (3) is provided inside the frame (2) and is adjusted to the work piece carrier (4).

11. A work table according to claim 10, wherein the base plate (3) is interchangeable.

12. A work table according to claim 7, wherein the work table comprises a mobile pallet.
